(19) United States
(12) Patent Application Publication
(10) Pub. No.: US 2024/0013504 A1
(43) Pub. Date: Jan. 11, 2024

(54) TECHNIQUES FOR WEAKLY SUPERVISED REFERRING IMAGE SEGMENTATION

(71) Applicant: NVIDIA CORPORATION, Santa Clara, CA (US)

(72) Inventors: Zhiding YU, Santa Clara, CA (US); Boyi LI, New York, NY (US); Chaowei XIAO, Seattle, WA (US); De-An HUANG, Davis, CA (US); Weili NIE, Sunnyvale, CA (US); Linxi FAN, San Jose, CA (US); Anima ANANDKUMAR, Pasadena, CA (US)

(21) Appl. No.: 17/977,884

(22) Filed: Oct. 31, 2022

Related U.S. Application Data
(60) Provisional application No. 63/388,091, filed on Jul. 11, 2022.

(51) Int. Cl. G06V 10/26; G06V 10/774; G06V 10/77; G06V 10/80; G06F 40/284

(52) U.S. Cl. CPC G06V 10/26; G06V 10/774; G06V 10/7715; G06V 10/80; G06F 40/284

(57) ABSTRACT

One embodiment of a method for training a machine learning model includes receiving a training data set that includes at least one image, text referring to at least one object included in the at least one image, and at least one bounding box annotation associated with the at least one object, and performing, based on the training data set, one or more operations to generate a trained machine learning model to segment images based on text, where the one or more operations to generate the trained machine learning model include minimizing a loss function that comprises at least one of a multiple instance learning loss term or an energy loss term

### CROSS-REFERENCE TO RELATED APPLICATIONS

This application claims priority benefit of the United States Provisional Patent Application titled, “TECHNIQUES FOR WEAKLY SUPERVISED REFERRING IMAGE SEGMENTATION,” filed on Jul. 11, 2022 and having Ser. No. 63/388,091. The subject matter of this related application is hereby incorporated herein by reference.

### BACKGROUND

### Technical Field

Embodiments of the present disclosure relate generally to computer science and machine learning and, more specifically, to techniques for weakly supervised referring image segmentation.

### Description of the Related Art

In machine learning, data is used to train machine learning models to perform various tasks. One type of task that machine learning models can be trained to perform is referring image segmentation. In referring image segmentation, a machine learning model determines object(s) or region(s) within an image that are referenced by a natural language expression. For instance, given an image and a natural language expression, a trained machine learning model could generate a segmentation mask that indicates which pixels within the image correspond to the natural language expression.

One conventional approach for training a machine learning model to perform referring image segmentation relies on a training data set that includes manually annotated segmentation masks. The manually annotated segmentation masks indicate individual pixels, within images in the training data set, that correspond to natural language expressions. During training, the machine learning model learns to generate segmentation masks that are similar to the manually annotated segmentation masks included in the training data set.

One drawback of the above approach is that the process of creating manually annotated segmentation masks is, as a general matter, quite tedious and time consuming. Further, a large number of manually annotated segmentation masks can be required to train a machine learning model to perform referring image segmentation. A large number of manually annotated segmentation masks are often not available to include in the requisite training data set. Even when manually annotated segmentation mask are available, the manually annotated segmentation masks can include errors and have poor quality. Accordingly, the above approach oftentimes cannot be used to train machine learning models to perform accurate referring image segmentation.

As the foregoing illustrates, what is needed in the art are more effective techniques for training machine learning models to perform referring image segmentation.

### SUMMARY

One embodiment of the present disclosure sets forth a computer-implemented method for training a machine learning model. The method includes receiving a training data set that includes at least one image, text referring to at least one object included in the at least one image, and at least one bounding box annotation associated with the at least one object. The method further includes performing, based on the training data set, one or more operations to generate a trained machine learning model to segment images based on text. The one or more operations to generate the trained machine learning model include minimizing a loss function that comprises at least one of a multiple instance learning loss term or an energy loss term.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that a machine learning model can be trained to perform referring image segmentation using a training data set that includes annotations of bounding boxes enclosing objects that appear within images. The bounding box annotations are more readily attainable than the manually annotated segmentation masks used by conventional techniques to train machine learning models to perform referring image segmentation. The disclosed techniques permit machine learning models to be trained for referring image segmentation when bounding box annotations, but not annotated segmentation masks, are available. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of the computing device of FIG. 1, according to various embodiments;

FIG. 3 is a more detailed illustration of the referring image segmentation model of FIG. 1, according to various embodiments;

FIG. 4 illustrates how the referring image segmentation model of FIG. 1 is trained, according to various embodiments;

FIG. 5 illustrates two exemplar segmentations of an image that are referenced by different natural language expressions, according to various embodiments;

FIG. 6 is a flow diagram of method steps for training a machine learning model to perform referring image segmentation, according to various embodiments; and

FIG. 7 is a flow diagram of method steps for applying a trained machine learning model to perform referring image segmentation, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for training and using a machine learning model to perform referring image segmentation. In the referring image segmentation, the machine learning model determines object(s) or region(s) within an image being referenced by a natural language expression. In some embodiments, the machine learning model includes (1) a text encoder that encodes the natural language expression referring to object(s) to generate text embedding(s), (2) a text adaptor that adapts the text embedding(s) for visual tasks to generate refined text embedding(s), (3) an image encoder that encodes the image to generate feature tokens, (4) a concatenation module that concatenates the refined text embedding(s) output by the text adaptor and the feature tokens output by the image encoder; (5) a convolution module that applies a convolution layer to fuse the concatenated refined text embedding(s) and feature tokens to generate flattened feature tokens, (6) a transformer encoder that generates refined feature tokens, (7) a location decoder that takes the refined feature tokens and randomly initialized queries as inputs and outputs location-aware queries, (8) a mask decoder that takes the refined feature tokens and the location-aware queries as inputs and outputs a mask, and (9) a convolution module that applies a convolution layer to the mask generated by the mask decoder to project the mask to one channel, thereby generating a segmentation mask that indicates pixels within the image that are associated with the object(s) referenced by the natural language expression.

In some embodiments, the machine learning model is trained to perform referring image segmentation using weak supervision in which the training data includes bounding box annotations enclosing objects within images, rather than manually annotated segmentation masks indicating pixels corresponding to those objects. In such cases, the training can include minimizing a loss function that includes a multiple instance learning (MIL) loss term and a conditional random field (CRF) loss term.

The techniques disclosed herein for training and utilizing a machine learning model to perform referring image segmentation have many real-world applications. For example, those techniques could be used to train a referring image segmentation model that is included in a home virtual assistant, robot, or any other suitable application that responds to voice or text commands by a user.

The above examples are not in any way intended to be limiting. As persons skilled in the art will appreciate, as a general matter, the techniques for referring image segmentation be implemented in any suitable application.

### System Overview

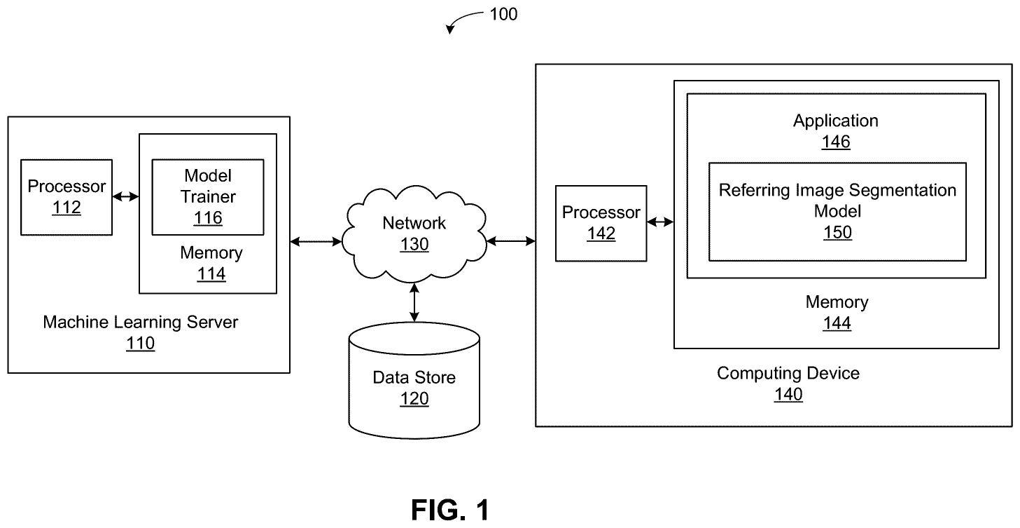

FIG. 1 is a block diagram illustrating a computer system 100 configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), or any other suitable network. In addition, the system 100 includes a robot 160 and one or more sensors 1801 (referred to herein collectively as sensors 180 and individually as a sensor 180) that are in communication with the computing device 140 (e.g., via a similar network). In some embodiments, the sensors can include one or more RGB (red, green, blue) cameras and optionally one or more depth cameras, such as cameras using time-of-flight sensors, LIDAR (light detection and ranging) sensors, etc.

As shown, a model trainer 116 executes on a processor 112 of the machine learning server 110 and is stored in a system memory 114 of the machine learning server 110. The processor 112 receives user input from input devices, such as a keyboard or a mouse. In operation, the processor 112 is the master processor of the machine learning server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the machine learning server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

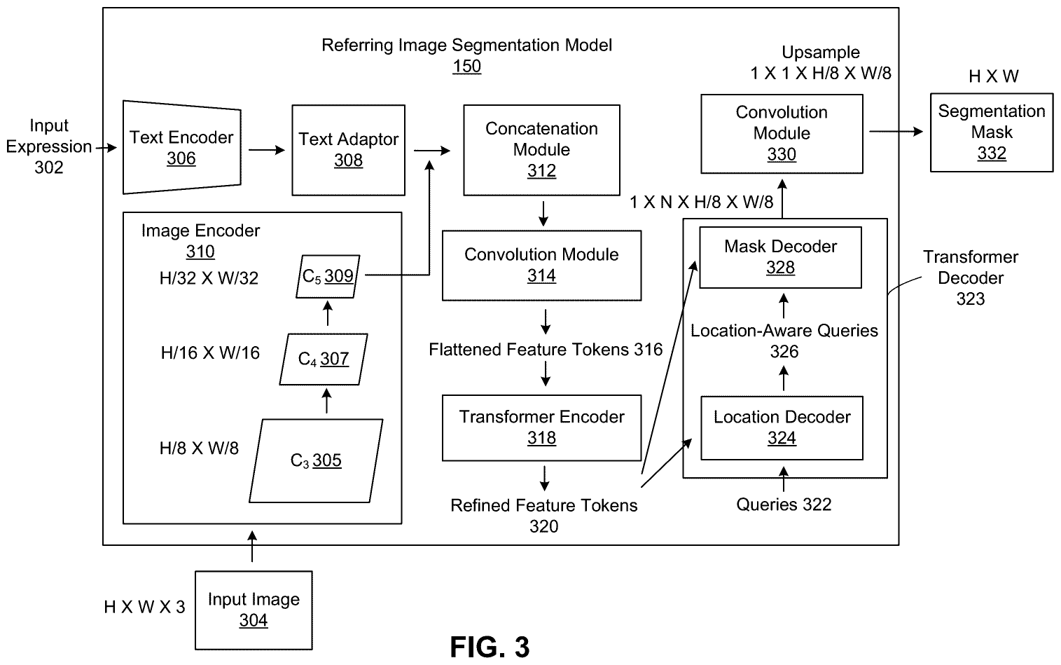

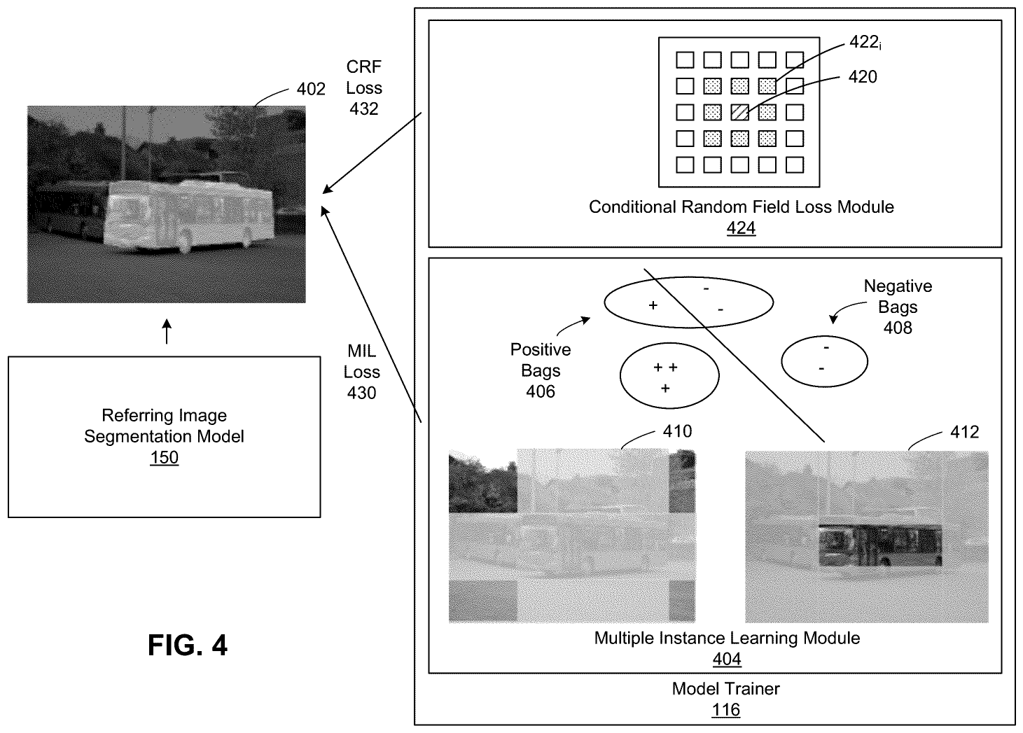

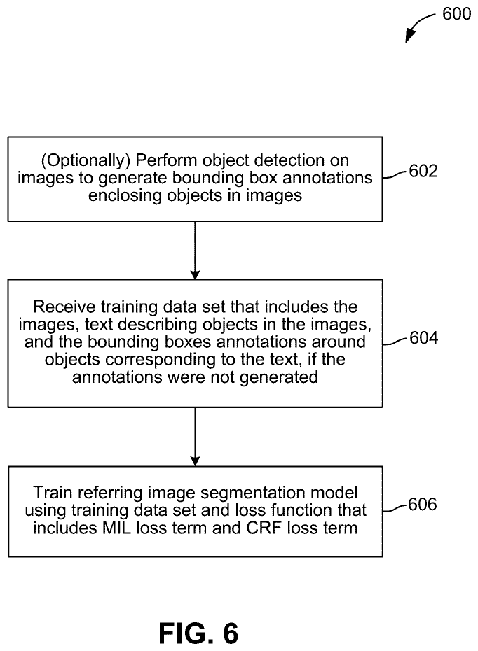

In some embodiments, the model trainer 116 is configured to train one or more machine learning models, including a referring image segmentation model 150. The referring image segmentation model 150 takes as inputs an image and a text expression that refers to object(s) in the image, and the referring image segmentation model 150 outputs a segmentation mask that indicates pixels of the image that are associated with the object(s) referred to in the text expression. An exemplar architecture of the referring image segmentation model 150 is discussed below in conjunction with FIG. 3. Techniques for weakly supervised training of the referring image segmentation model 150 based on bounding box annotations enclosing objects in a set of training images are discussed below in conjunction with FIGS. 4 and 6. Training data and/or trained machine learning models can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 can include the data store 120.

As shown, an application 146 that utilizes the referring image segmentation model 150 is stored in a system memory 144, and executes on a processor 142, of the computing device 140. Once trained, the referring image segmentation model 150 can be deployed, such as via the application 146, to perform referring image segmentation in conjunction with any technically feasible other task or tasks. For example, the referring image segmentation model 150 could be deployed in a home virtual assistant, robot, or any other suitable application that responds to voice or text commands by a user.

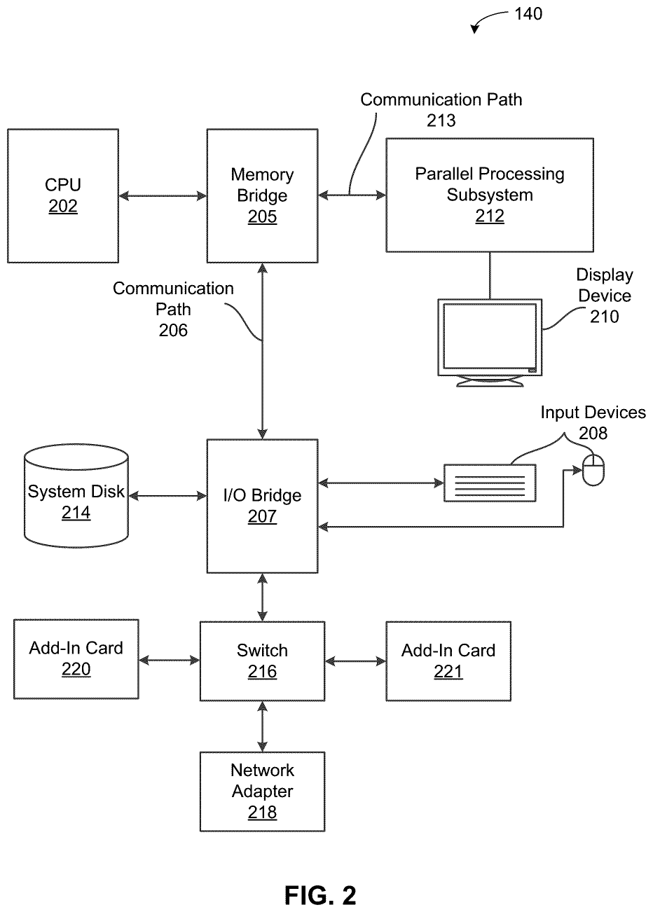

FIG. 2 is a block diagram of the computing device 140 of FIG. 1, according to various embodiments. As persons skilled in the art will appreciate, the computing device 140 can be any type of technically feasible computer system, including, without limitation, a server machine, a server platform, a desktop machine, laptop machine, a hand-held/mobile device, or a wearable device. In some embodiments, computing device 140 is a server machine operating in a data center or a cloud computing environment that provides scalable computing resources as a service over a network. In some embodiments, the machine learning server 110 can include similar components as the computing system 140.

In various embodiments, the computing device 140 includes, without limitation, the processor 142 and the memory 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard or a mouse, and forward the input information to processor 142 for processing via communication path 206 and memory bridge 205. In some embodiments, computing device 140 may be a server machine in a cloud computing environment. In such embodiments, computing device 140 may not have input devices 208. Instead, computing device 140 may receive equivalent input information by receiving commands in the form of messages transmitted over a network and received via the network adapter 218. In one embodiment, switch 216 is configured to provide connections between I/O bridge 207 and other components of the computing device 140, such as a network adapter 218 and various add-in cards 220 and 221.

In one embodiment, I/O bridge 207 is coupled to a system disk 214 that may be configured to store content and applications and data for use by processor 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 212. In other embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 144 includes at least one device driver configured to manage the processing operations of the one or more PPUs within parallel processing subsystem 212. In addition, the system memory 144 includes a rendering application 230. The rendering application 230 can be any technically-feasible application that renders virtual 3D scenes, and rendering the scenes can include rendering SDFs according to techniques disclosed herein. For example, the rendering application 230 could be a gaming application or a rendering application that is used in film production. Although described herein primarily with respect to the rendering application 230, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 1 to form a single system. For example, parallel processing subsystem 212 may be integrated with processor 142 and other connection circuitry on a single chip to form a system on chip (SoC).

In one embodiment, processor 142 is the master processor of computing device 140, controlling and coordinating operations of other system components. In one embodiment, processor 142 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 144 could be connected to processor 142 directly rather than through memory bridge 205, and other devices would communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 1 may not be present. For example, switch 216 could be eliminated, and network adapter 218 and add-in cards 220, 221 would connect directly to I/O bridge 207. Lastly, in certain embodiments, one or more components shown in FIG. 1 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Weakly Supervised Referring Image Segmentation

FIG. 3 is a more detailed illustration of the referring image segmentation model 150 of FIG. 1, according to various embodiments. As shown, the referring image segmentation model 150 includes a text encoder 306, a text adaptor 308, an image encoder 310, a concatenation module 312, a convolution module 314, a transformer encoder 318, a transformer decoder 323 that includes a location decoder 324 and a mask decoder 328, and a convolution module 330. Although described herein primarily with respect to a transformer as an illustrative example, in some embodiments, other types of image segmentation models, such as convolutional neural networks (CNNs), can be used in lieu of a transformer.

In operation, an image I∈R^{H×W×3}, 304, is input into the image encoder 310 of the referring image segmentation model 150. The image encoder 310 generates multi-scale feature maps C₃ 305, C₄ 307, and C₅ 309 that are ⅛ (i.e., H/8×W/8), 1/16 (i.e., H/16×W/16), and 1/32 (i.e., H/32×W/32) of the size of the input image 304. In some embodiments, the image encoder 101 includes a ResNet-101 neural network, which is a visual backbone that outputs the feature maps C₃ 305, C₄ 307, and C₅ 309 from the last three stages of the neural network.

In parallel (or not in parallel) to the above processing of the input image 304, a text expression 302 is input into the text encoder 306, which generates one or more text embeddings corresponding to the text expression 302. For example, in some embodiments, the text encoder 306 can generate a text embedding for each referring sentence in the text expression 302. The text expression 302 can be a natural language expression. In some embodiments, the text encoder 306 can be a pre-trained CLIP text encoder. CLIP is a multimodal recognition model providing pre-trained image and text encoder backbones that can be adapted for various tasks. The text embedding(s) output by the text encoder 306 are input into the text adaptor 308, which generates refined text embedding(s). In some embodiments, the text adaptor 308 includes (1) two linear layers whose input/output dimensions are 512/1024 and 1024/512, and (2) one ReLU (Rectified Linear Unit) layer, in order to better align text embedding(s) with the referring image segmentation task. Such a combination of two linear layers and one ReLU layer is also referred to herein as a “RefAdaptor.” The RefAdaptor is used to adapt the features output by a pre-trained text encoder 306 to new features that are more suitable for the task of referring image segmentation. In some other embodiments, any technically feasible text adaptor, such as a text adaptor that includes a different number of linear layers, can be used.

The concatenation module 312 concatenates the refined text embedding(s) output by the text adaptor 302 and the feature tokens output by the image encoder 310. Such a concatenation enables the referring image segmentation model 150 to perform multimodal tasks, and in particular referring image segmentation. In some embodiments, the concatenation includes concatenating the vector at every pixel location of a feature map output by the image encoder 310 with the refined text embedding(s) output by the text adaptor 308. For example, if the feature map output by the image encoder 310 has dimensions h×w×c and the text embedding(s) are represented by a c dimensional vector, then the concatenation can generate an h×w×2c result.

The convolution module 314 applies a convolution layer to fuse the concatenated refined text embedding(s) and feature tokens to generate flattened feature tokens 316, which have a smaller dimension corresponding to the dimension of inputs expected by the transformer encoder 318. In some embodiments, the feature maps 305, 307, and 309 generated by the image encoder 310 are projected to the dimension of 256 using a linear layer and then flattened into the feature tokens 316, denoted herein by C₃′, C₄′, and C₅′.

The flattened feature tokens 316 are input into the transformer encoder 318, which generates refined feature tokens 320. In some embodiments, the transformer encoder 318 is the transformer encoder of the Deformable DETR model. Such a transformer encoder permits attention to a small set of points around a reference point, which reduces computation costs, enables faster convergence, and promotes good attention representations for weakly supervised training using bounding box annotations, discussed in greater detail below in conjunction with FIG. 4.

The refined feature tokens 320 and N randomly initialized queries 322 are input into the transformer decoder 323. The transformer decoder 323 includes the location decoder 324 and the mask decoder 328. The location decoder 324 takes the refined feature tokens 320 and the N randomly initialized queries 322 as inputs and outputs location-aware queries 326. The location-aware queries 326 encode the location of object(s) referred to by the text expression 302, and the location-aware queries 326 can be useful for predicting the center location and scale of the object(s) in the image 304. In particular, the transformer decoder 323 aims to predict the localization referred to by the text expression 302, and the queries can be driven by localization losses during pretraining. In some embodiments, the transformer decoder 323 is the transformer decoder of the Deformable DETR model.

The refined feature tokens 320 and the location-aware queries 326 are input into the mask decoder 328. The mask decoder 328 predicts object masks using self-attention. In particular, the mask decoder 328 uses the location-aware queries 326 to attend the refined feature tokens 320, denoted herein by C₃″, C₄″, and C₅″, and to generate dense self-attention maps used to predict masks. Unlike the location decoder 324, the mask decoder 328 can require dense self-attention, rather than a sparse self-attention, to represent the predicted masks. In some embodiments, the dense self-attention can be achieved by taking the inner product between location-aware queries and the refined feature tokens 320 output by the transformer encoder 318. Such a design provides a “bottom-up” mechanism to promote attention to objects and further promotes naturally emerging segmentations for the weakly-supervised task of training the referring image segmentation model 150 using bounding box annotations, discussed in greater detail below in conjunction with FIG. 4. In particular, in some embodiments, the mask decoder 328 adopts a multi-head self-attention design with h=8 attention heads. Assuming that the lengths of C₃″, C₄″, and C₅″ are L₃, L₄, and L₅, respectively, the mask decoder 328 generates three attention maps A_{{3,4,5}} of sizes h×N×L_{{3,4,5}}. The attention maps A_{{3,4,5}} can further be interpolated into size h×N×L₃ and concatenated together. It should be noted that the referring image segmentation model 150 can directly use outputs of the location encoder 318 to predict query bounding boxes. In some embodiments, a linear layer is also used to aggregate the attention map channels into one channel corresponding to the object referred to by the input text expression 302, and the linear layer is followed by a sigmoid function that generates the mask output of the mask decoder 328. It should be noted that the above attention-based design is favorable for the task of weakly supervised learning from bounding box annotations, because the attention-based design promotes fine-grained attention that captures object details even when mask annotations are not available during training. Experience has shown that objects in images are captured well by the attention maps.

The convolution module 330 applies a convolution layer to the mask generated by the mask decoder 328 to project the mask to one channel, thereby generating the segmentation mask 332. In some embodiments, an output of the convolution module 330 can also be unsampled to generate the segmentation mask 332. The segmentation mask 332 is output by the referring image segmentation model 150 and indicates pixels within the input image 304 that correspond to the input text expression 302 (and pixels that do not correspond to the text expression 302).

FIG. 4 illustrates how the referring image segmentation model 150 of FIG. 1 is trained, according to various embodiments. As described, in some embodiments, the referring image segmentation model 150 is trained using weak supervision in which the training data includes bounding box annotations enclosing objects within images rather than manually annotated segmentation masks indicating pixels corresponding to those objects. As shown, the model trainer 116 includes (1) a multiple instance learning (MIL) module 404 that computes, for an image segmentation 402 generated by the referring image segmentation model 140 during training, an MIL loss 430; and a conditional random field (CRF) loss module 424 that computes, for the image segmentation 402, a CRF loss 432. In some embodiments, the MIL loss 430 and the CRF loss 432 are combined into a joint training loss for weakly supervised referring image segmentation training.

The goal of MIL is to train a classifier from a collection of labeled bags instead of labeled instances. Each bag includes a set of instances and is defined as positive if at least one of the instances is known to be positive. Otherwise, the bag is defined as negative. The task of training the referring image segmentation model 150 using weak supervision in which the training data includes bounding box annotations can be formulated as an MIL problem by considering positive and negative bags to be defined via a “bounding box tightness prior.” In the bounding box tightness prior, each row or column of pixels in an image is treated as a bag. A row or column is considered positive if the row or column passes the ground truth bounding box from the training data, because the row or column must include at least one pixel belonging to the object if the assumption is made that the ground truth bounding box tightly encloses the object. On the other hand, if a row or column does not pass through the ground truth bounding box, then the row or column is considered negative and includes only pixels from the background. Exemplar positive bags 406 and negative bags 408 are shown in FIG. 4. Also shown are (1) an exemplar image 410 that highlights rows and columns which pass through the ground truth bounding box of a bus object and are therefore considered positive; and (2) an exemplar image 142 that highlights rows and columns which do not pass through the ground truth bounding box of the bus and are therefore considered negative. More formally, assume that m∈ [symbol] ^{H×W} represents the mask probability map after a sigmoid. Let mᵢ be defined as a vector including the mask responses of the i-th bag (row or column) of m. The following Dice loss can be used to supervise

$${ℒ}_{m i l} = 1 - \frac{2 {\sum }_{i} [ {y}_{i} \cdot max ( {m}_{i} ) ]}{{\sum }_{i} {y}_{i}^{2} + {\sum }_{i} max {( {m}_{i} )}^{2}} , \qquad ( 1 )$$

where max (⋅) indicates taking the element with maximum value, and yᵢ=1 if the bag mᵢ is a positive one and yᵢ=0 otherwise. Intuitively, the argmax of every row and column for positive bags is likely to give the highest activation that will be located in the foreground after training, and the highest activation should be negative for negative bags. The max operation on the bags of activations mᵢ reduces the set of activations to a single output that is treated as the output of the entire bag. For positive bags, the output is positive, and vice versa for negative bags. The dice loss of equation (1) is similar to the cross entropy loss but work better for training a machine learning model to perform referring image segmentation.

The CRF loss 432, computed by the CRF loss module 424, is used to smooth and refine the segmentation masks generated by the referring image segmentation model 150. Using only an MIL loss, a trained referring image segmentation model can generate segmentation masks that include holes and other artifacts, whereas objects in images do not often have such holes or other artifacts. That is, the CRF loss 432 can be used to sharpen mask predictions. The goal is to perturb and create a structurally refined version of mask predictions via energy minimization, treating the referring image segmentation model 150 as a teacher model in an online manner. Although described herein with respect to the CRF loss 432 as a reference example, in some embodiments, other energies can be used to enable self-consistency regularization that smooths and/or refines segmentation masks generated by a referring image segmentation model. More formally, a random field X can be defined to represent a set of random variables, where each random variable characterizes the labeling of a pixel. Then, x∈{0,1}^{H×W} can be used to represent a particular labeling of X. In addition, let N (i) as the set of 8 immediate neighbors of pixel i. An exemplar pixel 420 and immediate neighboring pixels 4221 of the pixel 420 (referred to herein collectively as neighboring pixels 422 and individually as a neighboring pixel 422) are shown in FIG. 4. The CRF loss 432 defines the smoothness of labels (indicating whether each pixel is being referred to by the input text expression) between the center pixel label and the labels of the neighboring 8 pixels. When the pixel color are similar but the labels are different, the CRF loss 432 will have a relatively high value that penalizes such discontinuities in the labels. Assuming an initial mask prediction m, the model trainer 116 can minimize the following CRF energy during training of the referring image segmentation model 150 in some embodiments:

E(x)=μ(x)+ψ(x), (2)

where μ(x)=Σᵢϕ(xᵢ) represents unary potentials that are computed independently for each pixel from the mask prediction m. In addition, a pairwise potential can be defined as:

$$ψ ( x ) = {\sum }_{i ∈ r , j ∈ N ( i )} w exp ( - \frac{{\vert {I}_{i} - {I}_{j} \vert}^{2}}{2 {ζ}^{2}} ) [ {x}_{i} \neq {x}_{j} ] , \qquad ( 3 )$$

where w is the weight, and ζ is a hyperparameter that controls the sensitivity of the color contrastiveness. A minimization of the CRF energy x*=argminₓE(x) can be obtained using mean field interference, and the minimization of the CRF energy can be used to supervise the predicted mask:

$${ℒ}_{crf} = 1 - \frac{2 {\sum }_{i} [ {x}_{i}^{*} {m}_{i} ]}{{\sum }_{i} {x}_{i}^{* 2} + {\sum }_{i} {m}_{i}^{2}} , \qquad ( 4 )$$

where xᵢ*, and mᵢ are values of the i-th pixel in x* and m.

Given the MIL loss of equation (1) and the CRF loss of equation (4), a joint training loss for the weakly supervised training of the referring image segmentation model 150 can be written as:

[symbol]

= [symbol] ₘᵢₗ+λ_{crf} [symbol] _{crf}, (5)

where λ_{crf} is the loss weight for the CRF loss. Experience has shown that fixing λ_{crf}=1 works relatively well.

In addition to the joint training loss of equation (5), in some embodiments, a localization loss is used to guide learning of the location decoder 324. In such cases, bipartite graph matching can be used to assign predictions with ground truths, and the localization loss can include a GIoU (Generalized Intersection over Union) loss. Experience has shown that removing the localization loss helps during the weakly supervised referring image segmentation training described above. Accordingly, in some embodiments, the localization loss is not used during such weakly supervised referring image segmentation training.

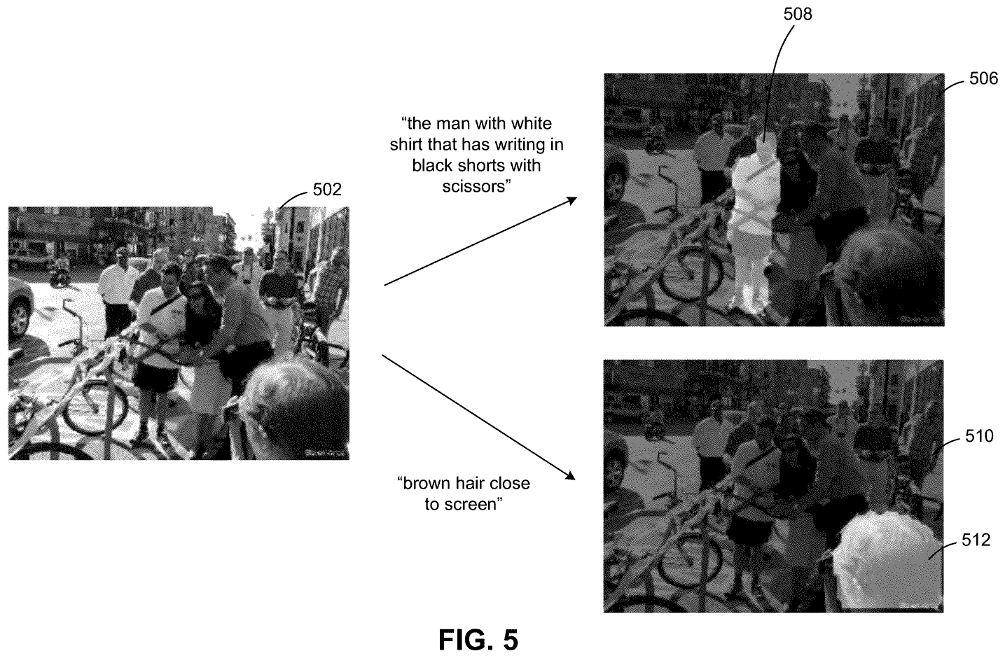

FIG. 5 illustrates two exemplar segmentations of an image that are referenced by different natural language expressions, according to various embodiments. As shown, an image 502 has been segmented based on the text expressions “the man with white shirt that has writing in black shorts with scissors” and “brown hair close to screen.” Results 506 and 510 of the segmentations are shown, in which regions of pixels 508 and 510 corresponding to the text expressions “the man with white shirt that has writing in black shorts with scissors” and “brown hair close to screen,” respectively, have been highlighted for illustrative purposes. In some embodiments, the image segmentation model 150 can be trained to generate segmentation masks indicating the regions 508 and 510, given the image 502 and the text expressions as input.

FIG. 6 is a flow diagram of method steps for training a machine learning model to perform referring image segmentation, according to various embodiments. Although the method steps are described in conjunction with the systems of FIGS. 1-2 and 4, persons skilled in the art will understand that any system configured to perform the method steps in any order falls within the scope of the present embodiments.

As shown, a method 600 begins at step 602, where the model trainer 116 optionally performs object detection on images to generate bounding box annotations enclosing objects in the images. More generally, bounding box annotations can be created in any technically feasible manner in some embodiments. For example, in some embodiments, bounding box annotations can be created manually, in which case step 602 can be omitted.

At step 604, the model trainer 116 receives a training data set that includes images, text that describes objects in the images, and bounding box annotations enclosing objects within the images that correspond to the text. Step 604 assumes that bounding box annotations were not generated by the model trainer 116 at optional step 602, such as if the bounding box annotations were created manually. If the bounding box annotations were generated at step 602, then the model trainer 116 does not receive bounding box annotations in some embodiments.

At step 606, the model trainer 116 trains a referring image segmentation model using the training data set and a loss function that includes an MIL loss term and a CRF loss term. Any technically feasible training technique, such as backpropagation with gradient descent, can be used to train the referring image segmentation model. In some embodiments, the referring image segmentation model has the architecture of the referring image segmentation model 150, described above in conjunction with FIG. 3. In some embodiments, the loss function is the joint training loss of equation (5), described above in conjunction with FIG. 4. Notably, even though annotated segmentation masks that indicate pixels, within images in the training data set, that correspond to natural language expressions are not available, such segmentations are learned automatically during the training of the referring image segmentation model.

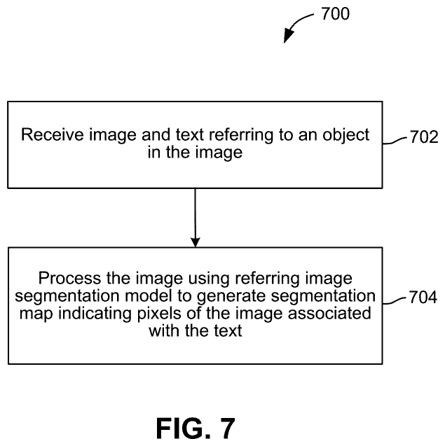

FIG. 7 is a flow diagram of method steps for applying a trained machine learning model to perform referring image segmentation, according to various embodiments. Although the method steps are described in conjunction with the systems of FIGS. 1-3, persons skilled in the art will understand that any system configured to perform the method steps in any order falls within the scope of the present embodiments.

As shown, a method 700 begins at step 702, where the application 146 receives an image and text referring to an object in the image. In some embodiments, the image can be a standalone image or a frame from a video that includes multiple frames.

At step 704, the application 146 processes the image using a referring image segmentation model to generate a segmentation map that indicates pixels of the image associated with the text. In some embodiments, the referring image segmentation model has the architecture of the referring image segmentation model 150, described above in conjunction with FIG. 3. Such a referring image segmentation model can be trained according to the method 600, described above in conjunction with FIG. 6.

In sum, techniques are disclosed for training and using a machine learning model to perform referring image segmentation. In some embodiments, the machine learning model includes (1) a text encoder that encodes an input natural language expression referring to object(s) to generate text embedding(s), (2) a text adaptor that adapts the text embedding(s) for visual tasks to generate refined text embedding(s), (3) an image encoder that encodes an input image to generate feature tokens, (4) a concatenation module that concatenates the refined text embedding(s) output by the text adaptor and the feature tokens output by the image encoder; (5) a convolution module that applies a convolution layer to fuse the concatenated refined text embedding(s) and feature tokens to generate flattened feature tokens, (6) a transformer encoder that generates refined feature tokens, (7) a location decoder that takes the refined feature tokens and randomly initialized queries as inputs and outputs location-aware queries, (8) a mask decoder that takes the refined feature tokens and the location-aware queries as inputs and outputs a mask, and (9) a convolution module that applies a convolution layer to the mask generated by the mask decoder to project the mask to one channel, thereby generating a segmentation mask that indicates pixels within the input image that are associated with the object(s) referred to in the input natural language expression. In some embodiments, the machine learning model is trained to perform referring image segmentation using weak supervision in which the training data includes bounding box annotations enclosing objects within images. In such cases, the training can involve minimizing a loss function that includes a MIL loss term and a CRF loss term.

At least one technical advantage of the disclosed techniques relative to the prior art is that a machine learning model can be trained to perform referring image segmentation using a training data set that includes annotations of bounding boxes enclosing objects that appear within images. The bounding box annotations are more readily attainable than the manually annotated segmentation masks used by conventional techniques to train machine learning models to perform referring image segmentation. The disclosed techniques permit machine learning models to be trained for referring image segmentation when bounding box annotations, but not annotated segmentation masks, are available. These technical advantages represent one or more technological improvements over prior art approaches.

1. In some embodiments, a computer-implemented method for training a machine learning model comprises receiving a training data set that includes at least one image, text referring to at least one object included in the at least one image, and at least one bounding box annotation associated with the at least one object, and performing, based on the training data set, one or more operations to generate a trained machine learning model to segment images based on text, wherein the one or more operations to generate the trained machine learning model include minimizing a loss function that comprises at least one of a multiple instance learning loss term or an energy loss term.

2. The computer-implemented method of clause 1, wherein the machine learning model comprises a text encoder that encodes text to generate one or more text embeddings, an image encoder that generates a feature map based on an image, and an image segmentation model that generates a mask based on the one or more text embeddings and the feature map.

3. The computer-implemented method of clauses 1 or 2, wherein the machine learning model further comprises a text adaptor that adapts the one or more text embeddings to generate one or more refined text embeddings.

4. The computer-implemented method of any of clauses 1-3, wherein the machine learning model further comprises a concatenation module that concatenates the one or more refined text embeddings and the feature map.

5. The computer-implemented method of any of clauses 1-4, wherein the machine learning model further comprises a first convolution layer that fuses a concatenation of the one or more refined text embeddings and the feature map, and a second convolution layer that projects the mask to one channel to generate a segmentation mask.

6. The computer-implemented method of any of clauses 1-5, wherein the image segmentation model comprises a transformer encoder that generates refined feature tokens based on the one or more text embeddings and the feature map, a location decoder that generates location-aware queries based on the refined feature tokens and random queries, and a mask decoder that generates the mask based on the location-aware queries and the refined feature tokens.

7. The computer-implemented method of any of clauses 1-6, wherein the machine learning model comprises a transformer model.

8. The computer-implemented method of any of clauses 1-7, wherein the text referring to the at least one object comprises one or more natural language expressions.

9. The computer-implemented method of any of clauses 1-8, further comprising processing a first image and a first text using the machine learning model to generate a segmentation mask indicating one or more objects in the first image that are referred to by the first text.

10. The computer-implemented method of any of clauses 1-9, wherein the energy loss term comprises a conditional random field loss term.

11. In some embodiments, one or more non-transitory computer-readable media store instructions that, when executed by at least one processor, cause the at least one processor to perform the steps of receiving a training data set that includes at least one image, text referring to at least one object included in the at least one image, and at least one bounding box annotation associated with the at least one object, and performing, based on the training data set, one or more operations to generate a trained machine learning model to segment images based on text, wherein the one or more operations to generate the trained machine learning model include minimizing a loss function that comprises at least one of a multiple instance learning loss term or an energy loss term.

12. The one or more non-transitory computer-readable media of clause 11, wherein the machine learning model comprises a text encoder that encodes text to generate one or more text embeddings, an image encoder that generates a feature map based on an image, and an image segmentation model that generates a mask based on the one or more text embeddings and the feature map.

13. The one or more non-transitory computer-readable media of clauses 11 or 12, wherein the machine learning model further comprises a text adaptor that adapts the one or more text embeddings to generate one or more refined text embeddings.

14. The one or more non-transitory computer-readable media of any of clauses 11-13, wherein the machine learning model further comprises a concatenation module that concatenates the one or more refined text embeddings and the feature map.

15. The one or more non-transitory computer-readable media of any of clauses 11-14, wherein the machine learning model further comprises a first convolution layer that fuses a concatenation of the one or more refined text embeddings and the feature map, and a second convolution layer that projects the mask to one channel to generate a segmentation mask.

16. The one or more non-transitory computer-readable media of any of clauses 11-15, wherein the image segmentation model comprises a transformer encoder that generates refined feature tokens based on the feature tokens, and a transformer decoder that generates the mask based on the refined feature tokens.

17. The one or more non-transitory computer-readable media of any of clauses 11-16, wherein the instructions, when executed by the at least one processor, further cause the at least one processor to perform the step of generating the at least one bounding box annotation by performing one or more object detection operations based on the at least one image.

18. The one or more non-transitory computer-readable media of any of clauses 11-17, wherein the instructions, when executed by the at least one processor, further cause the at least one processor to perform the step of processing a first image and a first text using the machine learning model to generate a segmentation mask indicating one or more objects in the first image that are referred to by the first text.

19. The one or more non-transitory computer-readable media of any of clauses 11-18, wherein the segmentation mask indicates one or more pixels in the first image that are associated with the one or more objects.

20. In some embodiments, a system comprises one or more memories storing instructions, and one or more processors that are coupled to the one or more memories and, when executing the instructions, are configured to receive a training data set that includes at least one image, text referring to at least one object included in the at least one image, and at least one bounding box annotation associated with the at least one object, and perform, based on the training data set, one or more operations to generate a trained machine learning model to segment images based on text, wherein the one or more operations to generate the trained machine learning model include minimizing a loss function that comprises at least one of a multiple instance learning loss term or an energy loss term.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model, the method comprising:
receiving a training data set that includes at least one image, text referring to at least one object included in the at least one image, and at least one bounding box annotation associated with the at least one object; and
performing, based on the training data set, one or more operations to generate a trained machine learning model to segment images based on text,
wherein the one or more operations to generate the trained machine learning model include minimizing a loss function that comprises at least one of a multiple instance learning loss term or an energy loss term.

2. The computer-implemented method of claim 1, wherein the machine learning model comprises:
a text encoder that encodes text to generate one or more text embeddings;
an image encoder that generates a feature map based on an image; and
an image segmentation model that generates a mask based on the one or more text embeddings and the feature map.

3. The computer-implemented method of claim 2, wherein the machine learning model further comprises a text adaptor that adapts the one or more text embeddings to generate one or more refined text embeddings.

4. The computer-implemented method of claim 3, wherein the machine learning model further comprises a concatenation module that concatenates the one or more refined text embeddings and the feature map.

5. The computer-implemented method of claim 3, wherein the machine learning model further comprises:
a first convolution layer that fuses a concatenation of the one or more refined text embeddings and the feature map; and
a second convolution layer that projects the mask to one channel to generate a segmentation mask.

6. The computer-implemented method of claim 2, wherein the image segmentation model comprises:
a transformer encoder that generates refined feature tokens based on the one or more text embeddings and the feature map;
a location decoder that generates location-aware queries based on the refined feature tokens and random queries; and
a mask decoder that generates the mask based on the location-aware queries and the refined feature tokens.

7. The computer-implemented method of claim 1, wherein the machine learning model comprises a transformer model.

8. The computer-implemented method of claim 1, wherein the text referring to the at least one object comprises one or more natural language expressions.

9. The computer-implemented method of claim 1, further comprising processing a first image and a first text using the machine learning model to generate a segmentation mask indicating one or more objects in the first image that are referred to by the first text.

10. The computer-implemented method of claim 1, wherein the energy loss term comprises a conditional random field loss term.

11. One or more non-transitory computer-readable media storing instructions that, when executed by at least one processor, cause the at least one processor to perform the steps of:
receiving a training data set that includes at least one image, text referring to at least one object included in the at least one image, and at least one bounding box annotation associated with the at least one object; and
performing, based on the training data set, one or more operations to generate a trained machine learning model to segment images based on text,
wherein the one or more operations to generate the trained machine learning model include minimizing a loss function that comprises at least one of a multiple instance learning loss term or an energy loss term.

12. The one or more non-transitory computer-readable media of claim 11, wherein the machine learning model comprises:
a text encoder that encodes text to generate one or more text embeddings;
an image encoder that generates a feature map based on an image; and
an image segmentation model that generates a mask based on the one or more text embeddings and the feature map.

13. The one or more non-transitory computer-readable media of claim 12, wherein the machine learning model further comprises a text adaptor that adapts the one or more text embeddings to generate one or more refined text embeddings.

14. The one or more non-transitory computer-readable media of claim 13, wherein the machine learning model further comprises a concatenation module that concatenates the one or more refined text embeddings and the feature map.

15. The one or more non-transitory computer-readable media of claim 13, wherein the machine learning model further comprises:
a first convolution layer that fuses a concatenation of the one or more refined text embeddings and the feature map; and
a second convolution layer that projects the mask to one channel to generate a segmentation mask.

16. The one or more non-transitory computer-readable media of claim 12, wherein the image segmentation model comprises:
a transformer encoder that generates refined feature tokens based on the feature tokens; and
a transformer decoder that generates the mask based on the refined feature tokens.

17. The one or more non-transitory computer-readable media of claim 11, wherein the instructions, when executed by the at least one processor, further cause the at least one processor to perform the step of generating the at least one bounding box annotation by performing one or more object detection operations based on the at least one image.

18. The one or more non-transitory computer-readable media of claim 11, wherein the instructions, when executed by the at least one processor, further cause the at least one processor to perform the step of processing a first image and a first text using the machine learning model to generate a segmentation mask indicating one or more objects in the first image that are referred to by the first text.

19. The one or more non-transitory computer-readable media of claim 11, wherein the segmentation mask indicates one or more pixels in the first image that are associated with the one or more objects.

20. A system, comprising:
one or more memories storing instructions; and
one or more processors that are coupled to the one or more memories and, when executing the instructions, are configured to:
receive a training data set that includes at least one image, text referring to at least one object included in the at least one image, and at least one bounding box annotation associated with the at least one object, and
perform, based on the training data set, one or more operations to generate a trained machine learning model to segment images based on text,
wherein the one or more operations to generate the trained machine learning model include minimizing a loss function that comprises at least one of a multiple instance learning loss term or an energy loss term.
